(19) United States
(12) Patent Application Publication
(10) Pub. No.: US 2008/0310515 A1
(43) Pub. Date: Dec. 18, 2008

(54) MPEG-2 2-Slice Coding for Simple Implementation of H.264 MBAFF Transcoder

(76) Inventors: Yasutomo Matsuba, Ibaraki (JP); Akira Osamoto, Ibaraki (JP)

Correspondence Address: TEXAS INSTRUMENTS INCORPORATED, P O BOX 655474, M/S 3999, DALLAS, TX, 75265, US

(21) Appl. No.: 12/137,847

(22) Filed: Jun. 12, 2008

Related U.S. Application Data
(60) Provisional application No. 60/943,878, filed on Jun. 14, 2007.

(51) Int. Cl. H04N 7/50

(52) U.S. Cl. 375/240.24; 375/E07.211

(57) ABSTRACT

This invention is a 2-slice MPEG-2 coding method. The MPEG-2 standard defines the slice structure where that the first and the last macroblock of a slice are in the same horizontal row of macroblocks. Two vertically adjacent macroblocks belong to two different slices. Any MPEG-2 slice can be decoded or encoded independently of other slices in the same frame because there is no dependency between slices. Due to these properties, this invention can decode or encode two consecutive macroblock rows alternately to fit the H.264 MBAFF scan order. This reduces the external memory access bandwidth and imposes no frame delay between decoder and encoder.

### CLAIM OF PRIORITY

This application claims priority under 35 U.S.C. 119(e)(1) to U.S. Provisional Application No. 60/943,878 filed Jun. 14, 2007.

### TECHNICAL FIELD OF THE INVENTION

The technical field of this invention is video data transcoding.

### BACKGROUND OF THE INVENTION

A transcoder changes the bitstream data format from one format to another format. A MPEG-2 to H.264 transcoder changes the bitstream data format from MPEG-2 format to H.264 format.

The H.264 standard provides macroblock-adaptive field-frame (MBAFF) coding to effectively encode interlaced video sequences. The application of MBAFF in transcoding is not straightforward because the macroblock (MB) order of the H.264 standard using MBAFF differs from the normal raster scan order followed by the MPEG-2 standards. FIG. 1 illustrates a comparison of the different scan orders of MBAFF encoded frames 110 (FIG. 1a) and ordinary scan encoded frames 120 (FIG. 1b). The MBAFF scan order proceeds from macroblock(i−2) to macroblock(i−1) to macroblock(i), macroblock (i+1) and to macroblock(i+2). Thus the MBAFF scan order covers two lines of macroblocks each pass through the width of frame 110. The ordinary scan order covers only one line of macroblocks from macroblock(i−1) to macroblock(i) and macroblock(i+1) in a first line, then the second line of macroblocks through macroblock(j−1) to macroblock(j) and macroblock(j+1)

Conventional H.264 MBAFF transcoding uses a frame based method. A decoder decodes one frame and writes this frame to external memory. An encoder reads the decoded frame from the external memory while changing the macroblock scan order. This absorbs the difference of the scan order.

FIG. 2 illustrates a schematic view of conventional MPEG-2 to H.264 MBAFF transcoding. The system includes a MPEG-2 to H.264 MBAFF transcoder 210 and external memory 220. Transcoder 210 includes MPEG-2 decoder 211, H.264 MBAFF encoder 212 and DMA and external memory controller (DMA) 213. H.264 MBAFF encoder 212 may encode video image in a H.264 standard bitstream including a MBAFF mode. Transcoder 210 performs the following sequence illustrated schematically in FIG. 2:

1) DMA 213 reads MPEG-2 bitstream data from external memory 220 and transmits it to MPEG-2 decoder 211.

2) MPEG-2 decoder 211 decodes one frame. DMA 213 stores this one frame of data in the ordinary scan order in external memory 220.

3) DMA 213 reads the decoded frame data from external memory 220 in MBAFF scan order and sends it to H.264 MBAFF encoder 212.

4) H.264 MBAFF encoder 212 encodes the frame data into a H.264 standard bitstream. DMA 213 writes this data to external memory 220.

The “information” in data transfers 2) and 3) in FIG. 2 is subsidiary information send from MPEG-2 decoder 211 to H.264 MBAFF encoder 212 through external memory 220. The subsidiary information includes motion vector information and the like. This subsidiary information is used by H.264 MBAFF encoder 212 to efficiently encode the bitstream.

FIG. 3 illustrates the construction of a conventional MPEG-2 decoder. MPEG-2 decoder 211 receives bitstream data via a bitstream buffer 311 from DMA 213. The length of this bitstream data is variable. Bitstream buffer 311 has a write pointer wr_ptr 312. This write pointer wr_ptr 312 enables DMA 213 to know which buffer address will receive the next bitstream write from DMA 213. Bitstream buffer 311 also has a read pointer rd_ptr 313 used for MPEG-2 decoder core 314 to know which buffer address to read.

MPEG-2 decoder 211 operates in the following sequence. MPEG-2 decoder core 314 reads bitstream data from address indicated by read pointer rd_ptr 313 in bitstream buffer 311. MPEG-2 decoder core 314 decodes the bitstream into macroblocks (MB). MPEG-2 decoder core 314 writes the macroblocks into MB data buffer 313. Read pointer rd_ptr 313 increments by the decoded bitstream size to point to the next incoming bitstream data. Thus MPEG-2 decoder core 314 decodes a macroblock and writes it to MB data buffer 315. Repeating this operation enables one frame decoding.

FIG. 4 illustrates a schematic view of conventional H.264 MBAFF to MPEG-2 transcoding. The system includes a H.264 MBAFF to MPEG-2 transcoder 410 and external memory 420. Transcoder 410 includes H.264 MBAFF decoder 411, MPEG-2 encoder 412 and DMA and external memory controller (DMA) 413. H.264 MBAFF decoder 411 may decode video image in a H.264 standard bitstream including a MBAFF mode. Transcoder 410 performs the following sequence illustrated schematically in FIG. 4:

1) DMA 413 reads H.264 MBAFF bitstream data from external memory 420 and transmits it to H.264 MBAFF decoder 411.

2) H.264 MBAFF decoder 411 decodes one frame. DMA 413 stores this one frame of data in the MBAFF scan order in external memory 420.

3) DMA 413 reads the decoded frame data from external memory 420 in ordinary scan order and sends it to MPEG-2 encoder 412.

4) MPEG-2 encoder 412 encodes the frame data into a MPEG-2 standard bitstream. DMA 413 writes this data to external memory 420.

The “information” in data transfers 2) and 3) in FIG. 4 is subsidiary information send from H.264 MBAFF decoder 411 to MPEG-2 encoder 412 through external memory 420. The subsidiary information includes motion vector information and the like. This information is used by MPEG-2 encoder 212 to efficiently encode the bitstream.

FIG. 5 illustrates the construction of a conventional MPEG-2 encoder. MPEG-2 encoder core 412 receives macroblocks via an MB data buffer 511 from DMA 413. MPEG-2 encoder core 412 produces bitstream data to be stored in bitstream buffer 513. The length of this bitstream data is variable. Bitstream buffer 513 has a write pointer wr_ptr 514. This write pointer wr_ptr 514 enables MPEG-2 encoder core 512 to know which buffer address will receive the next bitstream write. Bitstream buffer 513 also has a read pointer rd_ptr 515 used for DMA 413 to know which buffer address to read.

MPEG-2 decoder 411 operates in the following sequence. MPEG-2 encoder core 512 reads macroblock data from macroblock data buffer 511. MPEG-2 encoder core 512 encodes the macroblocks into bitstream data. MPEG-2 encoder core 512 writes the bitstream data into bitstream buffer 513 at the address stored in write pointer wr_ptr 514. Write pointer wr_ptr 514 increments by the decoded bitstream size to point to the next location for storage of bitstream data. Thus MPEG-2 encoder core 512 encodes a macroblock and writes the bitstream to bitstream buffer 513. DMA 413 transfers this bitstream data from bitstream buffer 513 to external memory 420 from an address specified by read pointer rd_ptr 515. Then read pointer 515 increments by the size of the macroblock. Repeating this operation enables one frame decoding.

The difference of scan order is absorbed by changing the macroblock order when encoder reads a macroblock from external memory in the two transcoding systems of FIGS. 2 and 4. This conventional method has the following problems. A frame delay occurs between decode and encoder because the encoder cannot start encoding until decoder finishes one frame. The system requires external memory and external memory access bandwidth because changing macroblock order is done through external memory. This second problem is serious in real-time high resolution transcoding system because high definition image transcoding usually needs a lot of external memory access bandwidth for processes other than the macroblock order change. The encoder quality depends on the motion estimation quality. Motion estimation quality depends on how much external memory access bandwidth motion estimation can use. Frame based transcoding reduces the external memory access bandwidth for motion estimation by requiring this for reordering macroblocks. This has a bad effect on encoder quality.

Consider a typical example. Assume external memory is 300 MHz, 32-bit DDR SDRAM. This memory has a maximum bandwidth of:

$$300 MHz * \frac{32 bits}{8 bits} * 2 = 2400 Mbits / sec$$

This maximum bandwidth is an ideal value. Bandwidth is usually lost in refreshing the SDRAM or in bank conflict. Assume an image format of 1920×1080 pixels at 30 fps. The external memory access bandwidth needed for changing scan order is:

$$( 1920 * 1080 pixels ) * 16 \frac{bits}{pixel} * 30 \frac{frames}{sec} * 1.5 ( Y , Cb , Cr ) \cdot \frac{2}{frame} = 373 MBytes$$

The two frames are required for each frame transcoding because one is needed for read and one for write. Note that for this example:

$$\frac{Scan Order Bandwidth}{Maximum Bandwidth} = 15.5 \%$$

Thus means the MBAFF macroblock scan re-ordering consumes more than 15% of the maximum SDRAM bandwidth. This may be critical for a high resolution image transcoding system.

### SUMMARY OF THE INVENTION

Real-time transcoding from MPEG-2 to H.264 or from H.264 to MPEG-2 imposes heavy requirements in external memory access bandwidth. This invention reduces the external memory access bandwidth compared to the conventional method. In this invention no frame delay occurs between decoder and encoder.

This invention proposes a 2-slice MPEG-2 coding method. The MPEG-2 standard defines the slice structures such that the first and the last macroblock of a slice are in the same horizontal row of macroblocks. Two vertically adjacent macroblocks belong to two different slices. Any MPEG-2 slice can be decoded or encoded independently of other slices in the same frame because there is no dependency between slices. Due to these properties, this invention can decode or encode two consecutive macroblock rows alternately to fit the H.264 MBAFF scan order.

### BRIEF DESCRIPTION OF THE DRAWINGS

These and other aspects of this invention are illustrated in the drawings, in which:

FIG. 1 illustrates a comparison of the different scan orders of MBAFF encoded frames and ordinary scan encoded frames;

FIG. 2 illustrates a schematic view of prior art MPEG-2 to H.264 MBAFF transcoding;

FIG. 3 illustrates the construction of a prior art MPEG-2 decoder;

FIG. 4 illustrates a schematic view of prior art H.264 MBAFF to MPEG-2 transcoding;

FIG. 5 illustrates the construction of a conventional MPEG-2 encoder;

FIG. 6 illustrates schematically the MPEG-2 to H.264 MBAFF transcoding system of this invention;

FIG. 7 illustrates the detailed construction of MPEG-2 decoder of this invention;

FIG. 8 illustrates the relationship between an upper slice and a lower slice for particular frame;

FIG. 9 illustrates the H.264 MBAFF to MPEG-2 transcoding system of this invention; and

FIG. 10 illustrates the structure of the two slice MPEG-2 encoder of this invention.

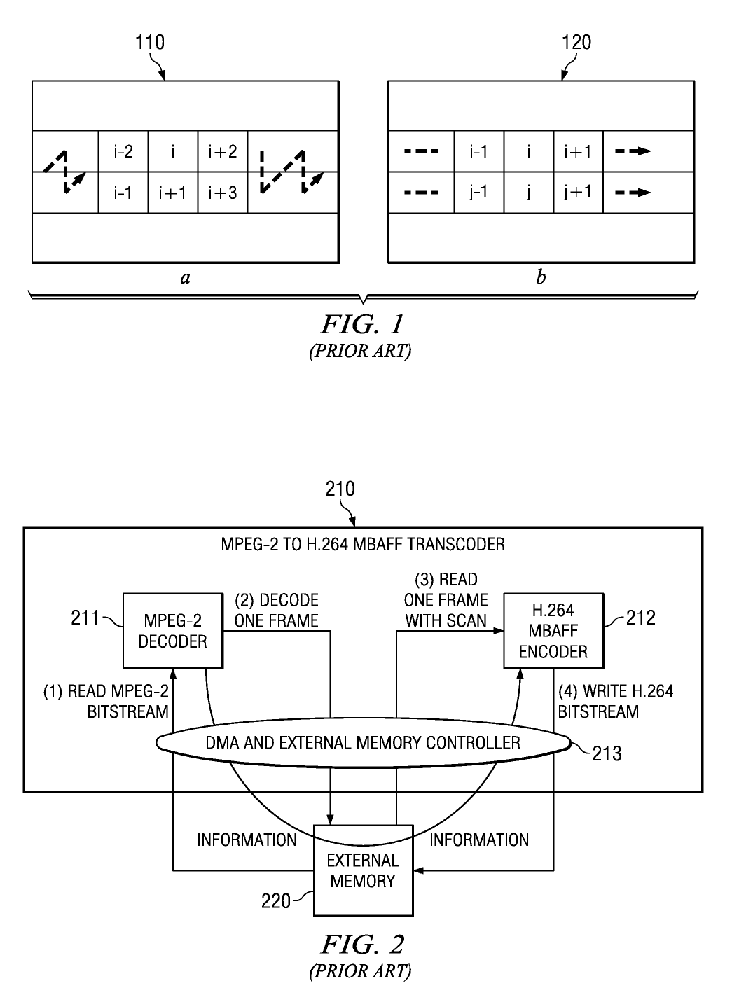

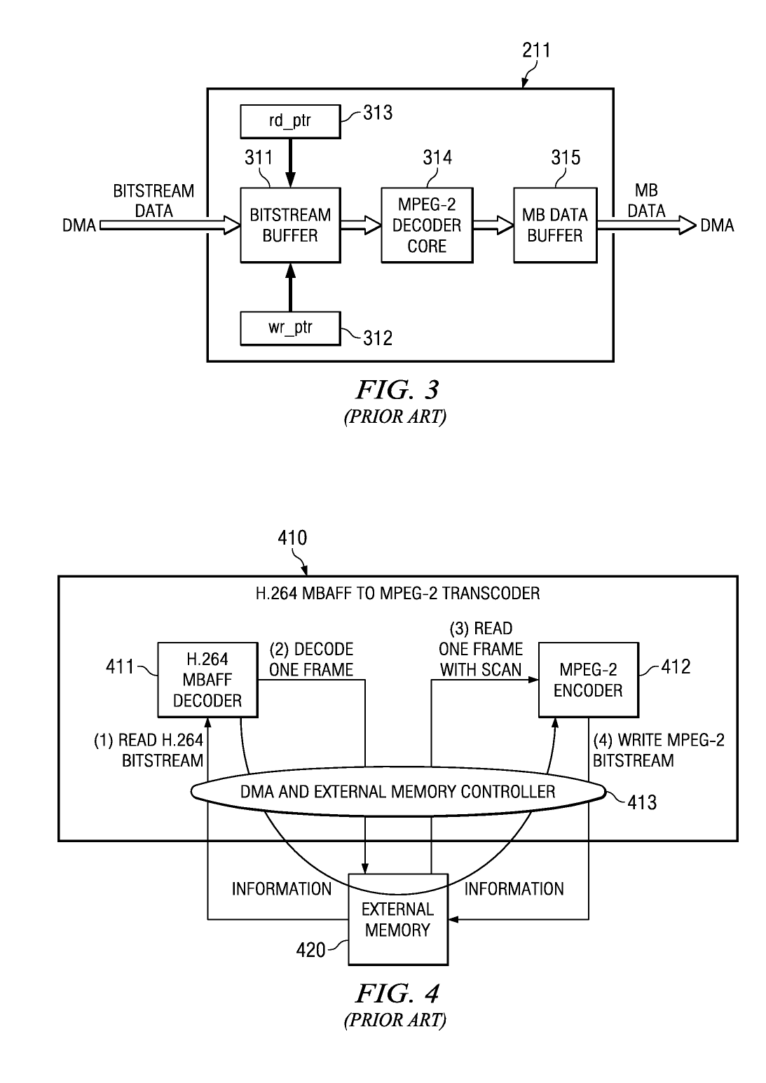

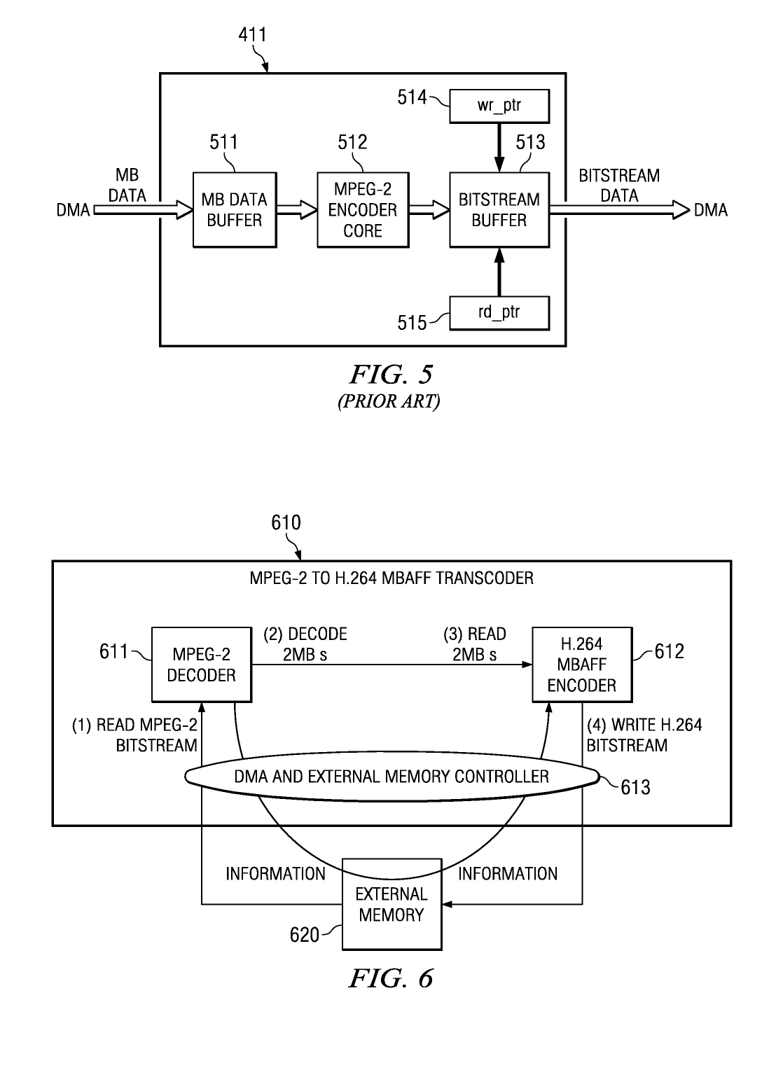

### DETAILED DESCRIPTION OF PREFERRED EMBODIMENTS

FIG. 6 illustrates schematically the MPEG-2 to H.264 MBAFF transcoding system of this invention. The transcoding system includes MPEG-2 to H.264 MBAFF transcoder 610 and external memory 620. Transcoder 610 includes MPEG-2 decoder 611, H.264 MBAFF encoder 612 and DMA 613. The transcoding system operates in the following sequence illustrated in FIG. 6:

1. DMA 613 reads MPEG-2 bitstream from external memory 620 and transmits it to MPEG-2 decoder 611.

2. MPEG-2 decoder 611 decodes two macroblocks in MBAFF scan order.

3. DMA 613 reads data from the two decoded macroblocks from MPEG-2 decoder 611 and transmits it H.264 MBAFF encoder 612.

4. H.264 MBAFF encoder 612 encodes the two macroblocks of data into a H.264 bitstream. DMA 613 writes this bitstream to external memory 620.

In this method, there is no external memory access between MPEG-2 decoder 611 and H.264 MBAFF encoder 612 to change macroblock scan order from ordinary scan order to MBAFF scan order. As shown in FIG. 6 only the subsidiary information needs to transfer to external memory 620 between generation by MPEG-2 decoder 611 and H.264 MBAFF encoder 612. This reduces needed external memory access compared to the conventional method.

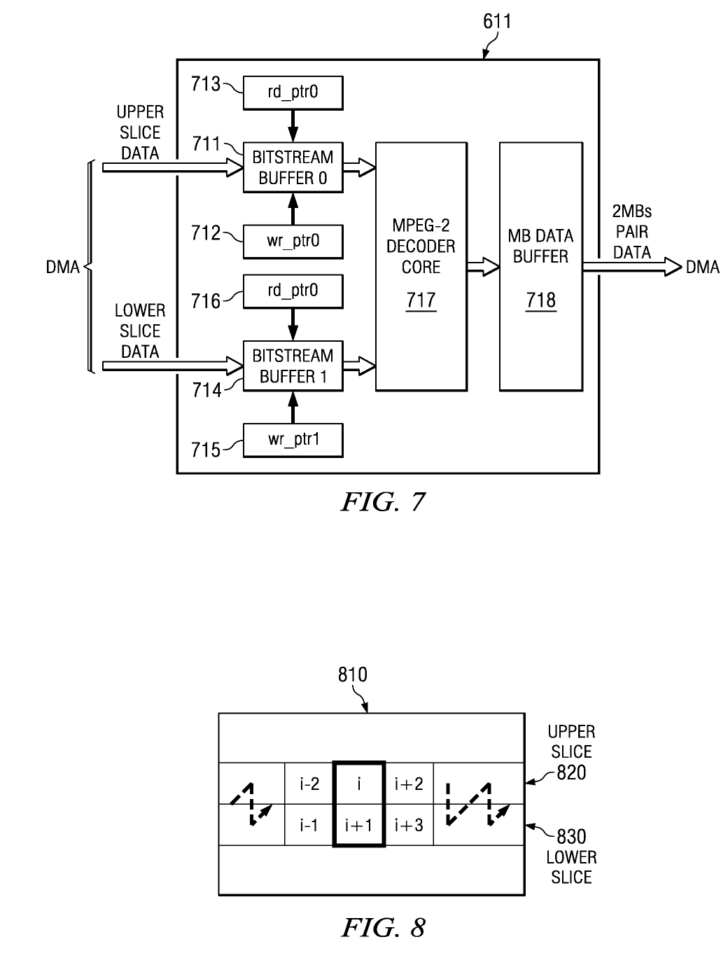

FIG. 7 illustrates the detailed construction of MPEG-2 decoder 611. MPEG-2 decoder 611 needs the capability to decode a MPEG-2 bitstream in MBAFF scan order. To decode a MPEG-2 bitstream in MBAFF scan order, MPEG-2 decoder 611 decodes a bitstream including upper slice data and lower slice data alternately. DMA 613 sends bitstream data including upper slice data to bitstream buffer 0 711 and bitstream data including lower slice data to bitstream buffer 1 718. The bitstream must be demuxed before MPEG-2 decoder core 717 can process the data. Thus DMA 613 sends different slice bitstreams to the two bitstream buffers 711 and 718.

FIG. 8 illustrates the relationship between an upper slice and a lower slice for frame 810. FIG. 8 shows the MBAFF scan order from macroblock(i−2) to macroblock(i−1) to macroblock(i), macroblock(i+1) and to macroblock(i+2). Upper slice 820 includes the top macroblock of each example macroblock pair; macroblock(i−2), macroblock(i) and macroblock(i+2). Lower slice 830 includes the bottom macroblock of each example macroblock pair; macroblock(i−1), macroblock(i+1) and macroblock(i+3).

The bitstream data is of variable length. Bitstream buffer 0 711 and bitstream buffer 1 718 require pointers to identify the addresses for DMA 613 write and for MEPG-2 decoder core 717 read. Bitstream buffers 711 and 718 thus include respective write pointers wr_ptr0 and wr_ptr1. These write pointers store buffer address where DMA 613 will write the next bitstream data. Bitstream buffers 711 and 718 also include respective read pointers rd_ptr0 and rd_ptr1. These read pointers store the buffer address where MPEG-2 decoder core 717 will next read.

MPEG-2 decoder 611 operates in the following sequence. DMA 613 writes upper slice bitstream data into bitstream buffer 711 at the address of write pointer wr_ptr0 712. Write pointer wr_ptr0 712 increments by the amount of the bitstream write. DMA 613 writes lower slice bitstream data into bitstream buffer 714 at the address of write pointer wr_ptr1 715. Write pointer wr_ptr1 714 increments by the amount of the bitstream write. MPEG-2 decoder core 717 initially reads upper slice bitstream data from the address rd_ptr0 of bitstream buffer 0 711. MPEG-2 decoder core 717 decodes this into a macroblock and writes the macroblock into MB data buffer 718. Read pointer rd_ptr0 increments by the decoded bitstream size. MPEG-2 decoder core 717 reads lower slice bitstream data from the address rd_ptr1 of bitstream buffer 1 711. MPEG-2 decoder core 717 decodes this into a macroblock and writes the macroblock into MB data buffer 718. Read pointer rd_ptr1 increments by the decoded bitstream size.

Thus MPEG-2 decoder core 717 decodes a macroblock pair, one macroblock in upper slice 820 and one macroblock in lower slice 830. MPEG-2 decoder core 717 writes both macroblocks into MB data buffer 718. The macroblock data in MB data buffer 718 is in MBAFF scan order. By repeating this operation, this system enables 2-slice alternate decoding.

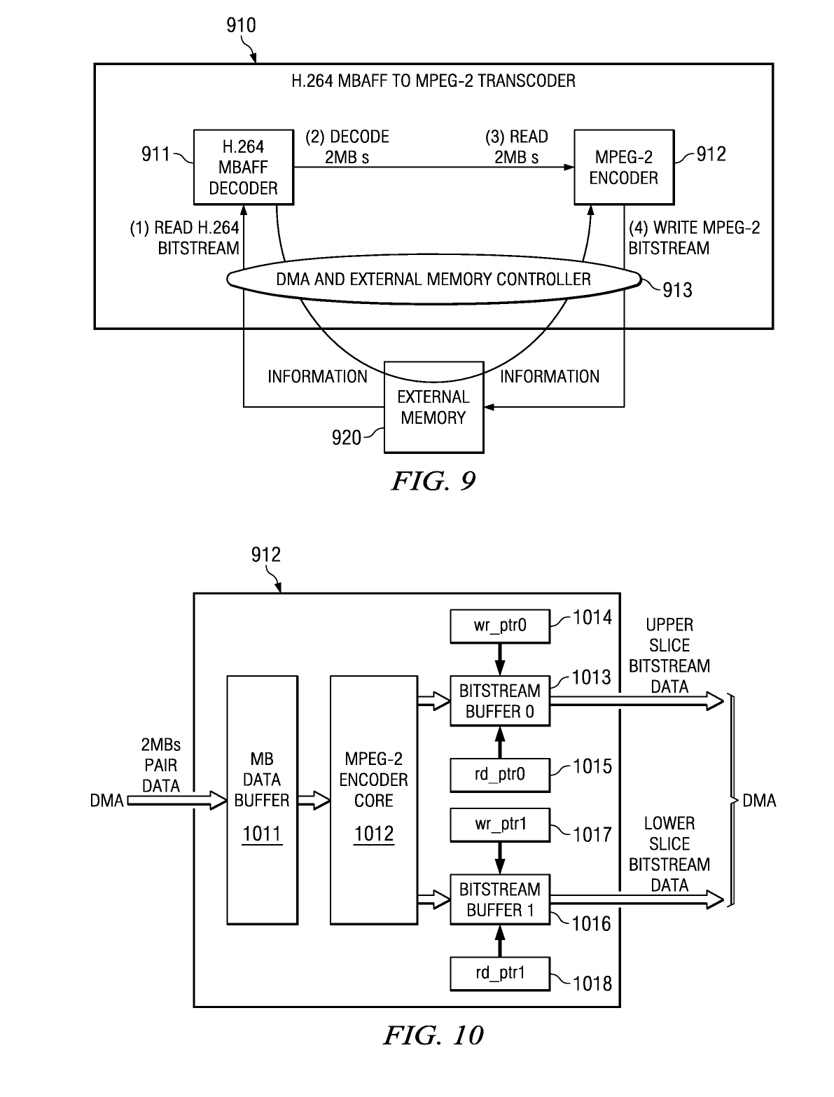

FIG. 9 illustrates the H.264 MBAFF to MPEG-2 transcoding system of this invention. The transcoding system includes H.264 MBAFF to MPEG-2 transcoder 910 and external memory 920. H.264 MBAFF to MPEG-2 transcoder 910 includes H.264 MBAFF decoder 911, MPEG-2 encoder 912 and DMA 913. Transcoder 910 operates in the following sequence:

1. DMA 913 reads H.264 MBAFF bitstream data from external memory 920 and transmits it to H.264 MBAFF decoder 911.

2. H.264 MBAFF decoder 911 decodes two macroblocks in MBAFF scan order (see FIG. 8).

3. DMA 913 reads the decoded pair of macroblocks from H.264 MBAFF decoder 911 and transmits them to MPEG-2 encoder 912.

4. MPEG-2 encoder 912 encodes the data of the two macroblocks into MPEG-2 bitstream data and writes this data to external memory 920 via DMA 913.

This method does not use external memory access between H.264 MBAFF decoder 911 and MPEG-2 encoder 912 for changing the macroblock scan order. As shown in FIG. 9 only the subsidiary information needs to transfer to external memory 620 between generation by H.264 MBAFF decoder 911 and MPEG-2 encoder 912. This reduces the needs external memory access compared to the conventional method (FIG. 4).

FIG. 10 illustrates the structure of the two slice MPEG-2 encoder 912. MPEG-2 encoder 912 requires the capability to encode two macroblocks into MPEG-2 bitstream data in the MBAFF scan order. The bitstream data is variable in length. Thus bitstream buffers 1013 and 1016 need read and write pointers. Bitstream buffers 1013 and 1016 have respective write pointers wr_ptr0 1014 and wr_ptr1 1017. These write pointers store the next buffer address to which MPEG-2 encoder core 1012 will next write. Bitstream buffers 1013 and 1016 have respective read pointers rd_ptr0 1015 and rd_ptr1 1018. These read pointers store the next buffer address from which DMA 913 will read.

MPEG-2 encoder 1012 operates in the following sequence. MPEG-2 encoder core 1012 receives bitstream data in MBAFF scan order. MPEG-2 encoder core 1012 encodes macroblock pairs; one from upper slice 820 and one from lower slice 830. The macroblock pairs are written to MB data buffer 1011 from H.262 MBAFF decoder 911 via DMA 913. MPEG-2 encoder core 1012 initially reads an upper macroblock from MB data buffer 1011, encodes it into a bitstream and writes the bitstream to Bitstream buffer 0 1013 at the location of write pointer wr_ptr0 1014. Write pointer wr_ptr0 1014 increments by the encoded bitstream size. MPEG-2 encoder core 1012 next reads lower macroblock data from MB Data Buffer 1011, encodes it into a bitstream and writes the bitstream to bitstream buffer 1 1016 at the location of write pointer wr_ptr1 1017. Write pointer wr_ptr1 1017 increments by the encoded bitstream size.

Thus MPEG-2 encoder core 1012 encodes a macroblock pair, one macroblock from upper slice 820 and one macroblock from lower slice 830. MPEG-2 decoder core 717 writes both macroblocks into MB data buffer 718. The macroblock data in MB data buffer 1011 is in MBAFF scan order. The upper slice bitstream data is stored in bitstream buffer 0 1013 and encoded lower slice bitstream data is stored in bitstream buffer 1 1016. This bitstream data is read by DMA 913 as steered by read pointers rd_ptr0 1014 and rd_ptr1 1017 and transferred to external memory 920. Both read pointers rd_ptr0 1015 and rd_ptr1 1018 are incremented by the sent bitstream size. Encoded upper slice bitstream and lower slice bitstream will be muxed after MPEG-2 encoder operation. Repeating this operation enables 2-slice alternate encoding.

This invention reduces external memory access bandwidth compared to the conventional method. For a video stream of 1920×1080 pixels at 30 fps images, the conventional method the external memory access bandwidth for changing macroblock scan order is 373 MBytes/sec. This invention needs no external memory access bandwidth for changing scan order. Any needed data order re-arrangement takes place at the input or output of the transcoder. This thus reduces the required memory access bandwidth by 373 MBytes/sec compared to the conventional method.

The conventional method produced a frame delay between decoder and encoder. This frame delay is needed for changing the macroblock scan order. However, this invention does not produce such a frame delay.

This invention enables real-time transcoding from MPEG-2 to H.264 MBAFF or from H.264 MBAFF to MPEG-2 with no frame delay and no external memory access for changing macroblock scan order between MBAFF scan order and ordinary scan order.

What is claimed is:

1. A method of transcoding from a first video stream encoded with macroblocks in an ordinary scanning order into a second video stream encoded with macroblocks in a macroblock-adaptive field-frame scanning order comprising the steps of:
storing the first video stream in a memory;
repeatably
transferring a first portion of the first video stream corresponding to a first macroblock in a vertical macroblock pair from the memory to a first bitstream buffer;
decoding a first macroblock corresponding to said first portion of the first video stream stored in the first bitstream buffer into the first macroblock of the vertical macroblock pair;
storing the decoded first macroblock in a macroblock buffer;
transferring a second portion of the first video stream corresponding to a second macroblock in the vertical macroblock pair from the memory to a second bitstream buffer;
decoding a second macroblock corresponding to said second portion of the first video stream stored in the second bitstream buffer into the second macroblock of the vertical macroblock pair,
storing the decoded second macroblock in a macroblock buffer;
recalling a decoded first macroblock from the macroblock buffer;
encoding the first macroblock into a first portion of the second video stream;
storing the first portion of the second video stream into the memory;
recalling a decoded second macroblock from the macroblock buffer;
encoding the second macroblock into a second portion of the second video stream; and
storing the second portion of the second video stream into the memory.

2. The method of claim 1, wherein:
said step of transmitting the first portion of the first video stream corresponding to the first macroblock the first bitstream buffer employs a first write pointer to designate a first write address in the first bitstream buffer;
said step of decoding the first macroblock corresponding to said first portion of the first video stream stored in the first bitstream buffer employs a first read pointer to designate a first read address in the first bitstream buffer;
said step of transmitting the second portion of the first video stream corresponding to the second macroblock from the memory to the second bitstream buffer employs a second write pointer to designate a second write address in the second bitstream buffer; and
said step of decoding the second macroblock corresponding to said second portion of the first video stream stored in the second bitstream buffer employs a second read pointer to designate a second read address in the second bitstream buffer.

3. The method of claim 2, wherein:
said first write pointer increments by an amount corresponding to a size of the first portion of the first video stream upon each write to the first bitstream buffer;
said first read pointer increments by an amount corresponding to a size of the first portion of the first video stream upon each read from the first bitstream buffer;
said second write pointer increments by an amount corresponding to a size of the second portion of the first video stream upon each write to the second bitstream buffer; and
said second read pointer increments by an amount corresponding to a size of the second portion of the first video stream upon each read from the second bitstream buffer.

4. An apparatus for transcoding from a first video stream encoded with macroblocks in an ordinary scanning order into a second video stream encoded with macroblocks in a macroblock-adaptive field-frame scanning order comprising:
an decoder including
a first bitstream buffer having an external memory connection;
a second bitstream buffer having an external memory connection;
an decoder core connected to said first bitstream buffer and said second bitstream buffer operable to alternately decode bitstream data stored in said first bitstream buffer and said second bitstream buffer in the first video format into corresponding macroblocks, and
a macroblock buffer connected to said decoder core for storing decoded macroblocks;
an encoder connected to said macroblock buffer and having an external memory connection operable to encode macroblocks into the second video format; and
a direct memory access unit connected to said first bitstream buffer, said second bitstream buffer, said macroblock buffer, said encoder and said encoder having an external memory connection operable to
transfer data from an external memory via said external memory connection to said first bitstream buffer,
transfer data from an external memory via said external memory connection to said second bitstream buffer,
transfer data from said macroblock buffer to said encoder, and
transfer data from said encoder to an external memory via said external memory connection.

5. The apparatus of claim 4, wherein:
said decoder further includes
a first write pointer storing an address in said first bitstream buffer, and
a second write pointer storing an address in said second bitstream buffer; and
said direct memory access unit is further operable to
transfer data from an external memory via said external memory connection to said first bitstream buffer to an address stored in said first write pointer, and
transfer data from an external memory via said external memory connection to said second bitstream buffer to an address stored in said second write pointer.

6. The apparatus of claim 5, wherein:
said first write pointer is operable to increment by an amount corresponding to a size of a data write following each write to said first bitstream buffer; and
said second write pointer is operable to increment by an amount corresponding to a size of a data write following each write to said second bitstream buffer.

7. The apparatus of claim 4, further comprising:
said decoder further includes
a first read pointer storing an address in said first bitstream buffer, and
a second read pointer storing an address in said second bitstream buffer; and
said decoder is further operable to
recall data from said first bitstream buffer at an address stored in said first read pointer, and
recall data from said second bitstream buffer at an address stored in said second write pointer.

8. The apparatus of claim 7, wherein:
said first read pointer is operable to increment by an amount corresponding to a size of a data read each data read from said first bitstream buffer; and
said second read pointer is operable to increment by an amount corresponding to a size of a data read upon each data read from said second bitstream buffer.

9. A method of transcoding from a first video stream encoded with marcoblocks in a macroblock-adaptive field-frame scanning order into a second video stream encoded with macroblocks in an ordinary scanning order comprising the steps of:
storing the first video stream in a memory;
repeatably
transferring a first portion of the first video stream corresponding to a first macroblock in a vertical macroblock pair from the memory to a decoder;
decoding a first macroblock corresponding to said first portion of the first video stream into the first macroblock of the vertical macroblock pair;
storing said first decoded macroblock in a macroblock buffer;
transferring a second portion of the first video stream corresponding to a second macroblock in the vertical macroblock pair from the memory to said decoder;
decoding a second macroblock corresponding to said second portion of the first video stream into the second macroblock of the vertical macroblock pair,
storing said second macroblock in said macroblock buffer;
recalling a decoded first macroblock from the macroblock buffer;
encoding the first macroblock into a first portion of the second video stream;
storing the first portion of the second video stream into a first bitstream buffer;
recalling a decoded second macroblock from the macroblock buffer;
encoding the second macroblock into a second portion of the second video stream;
storing the second portion of the second video stream into a second bitstream buffer;
transferring the first portion of the second video stream stored in the first bitstream buffer to memory; and
transferring the second portion of the second video stream stored in the second bitstream buffer to memory.

10. The method of claim 9, wherein:
said step of encoding the first macroblock corresponding to said first portion of the first video stream employs a first write pointer to designate a first write address in the first buffer;
said step of transferring the first portion of the first video stream corresponding to the first macroblock stored in the first bitstream buffer to memory employs a first read pointer to designate a first read address in the first bitstream buffer;
said step of encoding the second macroblock corresponding to said second portion of the first video stream employs a second write pointer to designate a second write address in the second bitstream buffer; and
said step of transferring the second portion of the first video stream corresponding to the second macroblock stored in the second buffer to memory employs a second read pointer to designate a second read address in the second bitstream buffer.

11. The method of claim 10, wherein:
said first write pointer increments by an amount corresponding to a size of the first portion of the first video stream upon each write to the first bitstream buffer;
said first read pointer increments by an amount corresponding to a size of the first portion of the first video stream upon each read from the first bitstream buffer;
said second write pointer increments by an amount corresponding to a size of the second portion of the first video stream upon each write to the second bitstream buffer; and
said second read pointer increments by an amount corresponding to a size of the second portion of the first video stream upon each read from the second bitstream buffer.

12. An apparatus for transcoding from a first video stream encoded with macroblocks in a macroblock-adaptive field-frame scanning order into a second video stream encoded with macroblocks in an ordinary scanning order comprising:
an decoder having an external memory connection operable to decode bitstream data in the first video format into corresponding macroblocks;
an encoder having
a macroblock buffer connected to said decoder for storing decoded macroblocks;
a first bitstream buffer having an external memory connection,
a second bitstream buffer having an external memory connection;
an encoder core connected to said macroblock buffer, said first bitstream buffer and said second bitstream buffer operable to encode macroblocks into bitstream data in the second video format and store alternately encoded bitstream data in said first bitstream buffer and said second bitstream buffer; and
a direct memory access unit connected to said encoder, said macroblock buffer, said decoder, said first bitstream buffer and said second bitstream buffer having an external memory connection operable to
transfer data from an external memory via said external memory connection to said decoder,
transfer data from said decoder buffer to said macroblock buffer,
transfer data form said first bitstream buffer to an external memory via said external memory connection, and
transfer data form said second bitstream buffer to an external memory via said external memory connection.

13. The apparatus of claim 12, wherein:
said encoder further includes
a first read pointer storing an address in said first bitstream buffer, and
a second read pointer storing an address in said second bitstream buffer; and
said direct memory access unit is further operable to
transfer data from said first bitstream buffer to an external memory via said external memory connection from an address stored in said first read pointer, and
transfer data from said second bitstream buffer to an external memory via said external memory connection from an address stored in said second read pointer.

14. The apparatus of claim 13, wherein:
said first read pointer is operable to increment by an amount corresponding to a size of a data read following each read from said first bitstream buffer; and
said second read pointer is operable to increment by an amount corresponding to a size of a data read following each read from said second bitstream buffer.

15. The apparatus of claim 12, further comprising:
said encoder further includes
a first write pointer storing an address in said first bitstream buffer, and
a second write pointer storing an address in said second bitstream buffer; and
said encoder is further operable to
store data in said first bitstream buffer at an address stored in said first write pointer, and
store data from said second bitstream buffer at an address stored in said second read pointer.

16. The apparatus of claim 15, wherein:
said first write pointer is operable to increments by an amount corresponding to a size of a data write each data write to said first bitstream buffer; and
said second write pointer is operable to increment by an amount corresponding to a size of a write read upon each data write to said second bitstream buffer.
